(19) United States
(12) Patent Application Publication
(10) Pub. No.: US 2017/0194883 A1
(43) Pub. Date: Jul. 6, 2017

(54) PLATFORM SYSTEM

(71) Applicant: ZEROTECH (Chongqing) Intelligence Technology Co., Ltd., Chongqing (CN)

(72) Inventors: Hong-Tao Sun, Beijing (CN); Xian-Wei Ren, Beijing (CN); Chao Wang, Beijing (CN)

(73) Assignee: ZEROTECH (Chongqing) Intelligence Technology Co., Ltd., Chongqing (CN)

(21) Appl. No.: 15/395,455

(22) Filed: Dec. 30, 2016

(30) Foreign Application Priority Data
Jan. 5, 2016 (CN) 201620009113.2

(51) Int. Cl. H02P 5/00; H02K 11/00

(52) U.S. Cl. CPC H02P 5/00; H02K 11/00

(57) ABSTRACT

A platform system includes at least one electric motor, at least one flexible cable, and a main controlling device. The main controlling device includes a controlling circuit and at least one driving circuit electrically connected to the controlling circuit. The at least one driving circuit is connected to the at least one electric motor through the at least one flexible cable.

### CROSS-REFERENCE TO RELATED APPLICATIONS

This application claims all benefits accruing under 35 U.S.C. §119 from Chinese Patent Application No. 201620009113.2, filed on Jan. 5, 2016, in the State Intellectual Property Office of China, the content of which is hereby incorporated by reference.

### FIELD

The present disclosure relates to platforms for carrying payloads.

### BACKGROUND

A vehicle may carry a payload through a platform to perform a task, such as aerial photography, surveillance, resource exploration, geological survey, and remote sensing. For example, an unmanned aerial vehicle may be equipped with a gimbal for carrying a camera. The platform can comprise a motor and a rotating member driven by the motor to rotate the payload about an axis, such as a pitch axis, a roll axis, or a yaw axis, to adjust an orientation of the payload (e.g., to adjust a shooting angle of a camera). The motor can be driven to rotate by a motor driver, which applies electric power to the motor. To control the rotating of the payload, a controller may transmit data signals to the motor driver through a cable connected therebetween.

### BRIEF DESCRIPTION OF THE DRAWINGS

Implementations are described by way of example only with reference to the attached figures.

FIG. 1 is a schematic view of one embodiment of a platform system.

FIG. 2 is a block diagram of one embodiment of the platform system.

FIG. 3 is an enlarged view of a portion in circle I of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

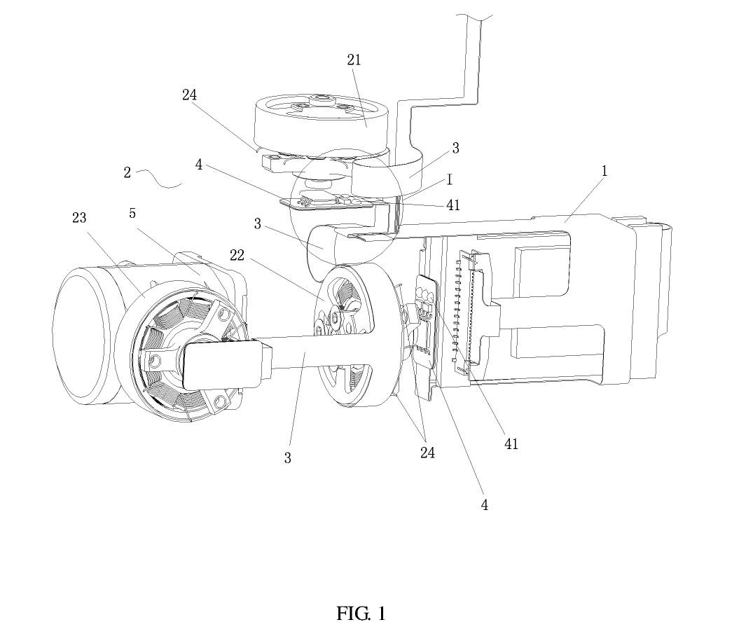

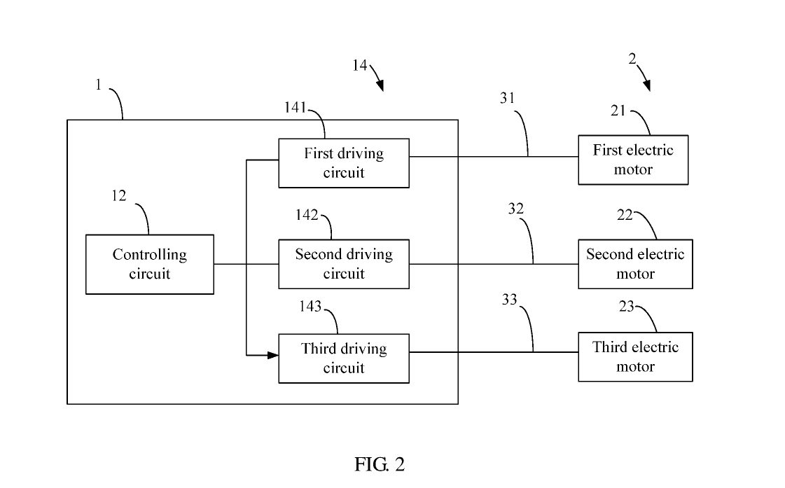

Referring to FIG. 1 and FIG. 2, one embodiment of a platform system comprises a main controlling device 1 and at least one electric motor 2. The main controlling device 1 comprises a controlling circuit 12 and at least one driving circuit 14. The controlling circuit 12 is electrically connected to the driving circuit 14 and transmits a controlling signal to the at least one driving circuit 14. The controlling signal can comprise a speed signal. The driving circuit 14 is configured to receive the controlling signal, and apply an electric power to the electric motor 2 according to the controlling signal thereby driving the electric motor 2 to rotate (e.g., to rotate at a speed according to the speed signal). The electric motor 2 is configured to transform the electric power to a dynamic power and output a torque (e.g., to rotate at the speed) thereby rotating a payload 5 about at least one axis.

The controlling circuit 12 and the at least one driving circuit 14 can be integrated as one integrated device. In one embodiment, the controlling circuit 12 and the at least one driving circuit 14 are mounted on one circuit board. The at least one electric motor 2 can be electrically connected to the at least one driving circuit 14 in a one-to-one manner through a flexible cable 3. The flexible cable 3 can be such as a flexible printed circuit (FPC), a ribbon cable, a multi-wire planer cable, or a flexible flat cable. In one embodiment, the flexible cable 3 is the FPC. The integration of the controlling circuit 12 and the at least one driving circuit 14 can avoid a signal loss caused by a long distance signal transmission. The flexible cable 3 can comprise one or more cable wires having an amount decided by a type of the electric motor 2. In one embodiment, the electric motor 2 is a brushless electric motor (e.g., brushless DC motor) comprising a number of electromagnetic coils (e.g., three coils), and the flexible cable 3 comprises the same number of cable wires (e.g., three cable wires). In another embodiment, the electric motor 2 is a brushed electric motor (e.g., brushed DC motor), and the flexible cable 3 comprises two cable wires.

In one embodiment, the platform system comprises a first electric motor 21 and a first driving circuit 141 corresponding to the first electric motor 21. The first electric motor 21 can be electrically connected to the first driving circuit 141 through a first flexible cable 31. The first electric motor 21 is configured to output a rotation to rotate a payload 5 about a first rotating axis.

In one embodiment, the platform system can further comprise a second electric motor 22 and a second driving circuit 142 corresponding to the second electric motor 22. The second electric motor 22 can be electrically connected to the second driving circuit 142 through a second flexible cable 32. The second electric motor 22 is configured to output a rotation to rotate a payload 5 about a second rotating axis.

In one embodiment, the platform system can further comprise a third electric motor 23 and a third driving circuit 143 corresponding to the third electric motor 23. The third electric motor 23 can be electrically connected to the third driving circuit 143 through a third flexible cable 33. The third electric motor 23 is configured to output a rotation to rotate a payload 5 about a third rotating axis.

The first, second, and third rotating axes can be the pitch axis, the roll axis, and the yaw axis, respectively.

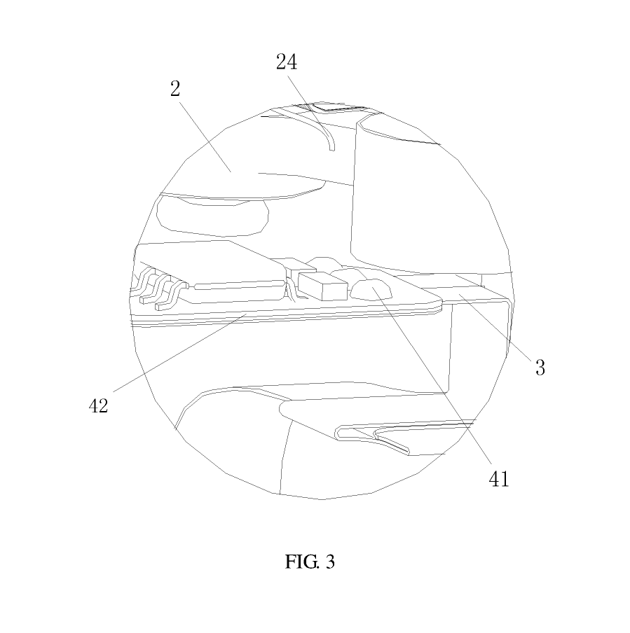

In one embodiment, each electric motor 2 comprises a rotor, a stator, and an electromagnetic coil. Referring to FIG. 3, the electromagnetic coil comprises at least one conducting wire 24 having one end extended out from the electric motor 2. The conducting wire 24 can be a copper wire or an enamel insulated wire. The conducting wire 24 is electrically connected to the corresponding driving circuit 14 through the corresponding flexible cable 3. The extended end of the conducting wire 24 can be joined with the flexible cable 3 through a metal-joining means such as welding, soldering, or brazing.

In one embodiment, the platform system can further comprise at least one metal-joining plate 4 for the welding, soldering, or brazing. The metal-joining plate 4 can comprise a base board 42 and a joining member 41 located on the base board 42. The joining member 41 can be electrically and mechanically connected to the flexible cable 3. In one embodiment, a number of the joining members 41 can be electrically and mechanically connected to a number of the cable wires of the flexible cable 3 in a one-to-one manner. The joining member 41 is configured to join the extended end of the conducting wire 24. In one embodiment, the joining member 41 is a solder terminal having the conducting wire 24 soldered thereon. The metal-joining plate 4 can be a solder board 42, and the solder terminal 41 can be a solder protrusion, a solder ring, or a solder lug located on the solder board 42. The amount of the joining members 41 is equal to the amount of the conducting wires 24 thereby joining the conducting wires 24 in a one-to-one manner.

In one embodiment, the electric motor 2 is a brushless electric motor comprising three conducting wires 24 extended from three electromagnetic coils. The metal-joining plate 4 comprises three joining members 41 configured to respectively join the end of the three conducting wires 24.

In one embodiment, the electric motor 2 is a brushed electric motor (e.g., brushed DC motor) comprising two conducting wires 24 extended out from a commutator of the brushed electric motor. The metal-joining plate 4 comprises two joining members 41.

The platform system can comprise more than one metal-joining plates 4 corresponding to the more than one electric motors 2 in a one-to-one manner.

In one embodiment, the platform system comprises the first electric motor 21, a first metal-joining plate 4 mounted on the first electric motor 21, the first flexible cable 31, and the first driving circuit 141. The first electric motor 21 comprises a first conducting wire 24 having one end extended out from the electric motor 21 and joined to the first metal-joining plate 4. The first metal-joining plate 4 is configured to electrically connecting the first conducting wire 24 to the first flexible cable 3.

In another embodiment, the platform system further comprises the second electric motor 22, a second metal-joining plate 4 mounted on the second electric motor 22, the second flexible cable 32, and the second driving circuit 142. The second electric motor 22 comprises a second conducting wire 24 having one end extended out from the electric motor 22 and joined to the second metal-joining plate 4. The second metal-joining plate 4 is configured to electrically connecting the second conducting wire 24 to the second flexible cable 32.

In yet another embodiment, the platform system further comprises the third electric motor 23, a third metal-joining plate 4 mounted on the third electric motor 23, the third flexible cable 33, and the third driving circuit 143. The third electric motor 23 comprises a third conducting wire 24 having one end extended out from the electric motor 23 and joined to the third metal-joining plate 4. The third metal-joining plate 4 is configured to electrically connecting the third conducting wire 24 to the third flexible cable 33.

The platform system can further comprise at least one support member (not shown) having one end secured to the electric motor 2 and the other end outputting the rotation of the rotor of the electric motor 2. In one embodiment, the other end of the support member is mounted with a payload such as a camera 5.

In use of the platform system in the field of a vehicle, such as an unmanned aerial vehicle, the controlling device may be far away from the electric motor. In conventional art, the electric motor and a driving device are mounted together, and a cable is extended from the driving device to electrically connect with the controlling device. The driving device takes space on the electric motor, which is adverse for minimization of the platform system. The cable may include a large number of signal wires and connecting terminals for sending the multiple controlling signals from the controlling device to driving device, which may have a signal loss during the transmission.

Compare to conventional art whose motor driver is integrated to the electric motor, the present disclosure has the controlling circuit 12 and the at least one driving circuit 14 integrated as one integrated circuit, thereby avoiding a single loss caused by a long distance signal transmission between the controlling circuit 12 and the driving circuit 14. Further, the connection between the driving circuit 14 and the electric motor 2 is simpler than the connection between the conventional driving device and the controlling device in that the connection between the driving circuit 14 and the electric motor 2 only needs a small number of conducting wires in the flexible cable 3, which greatly decreases a width and a number of terminals of the flexible cable 3.

The metal-joining means avoids using a space taking connector such as a pair of plug and socket. Thereby, the connecting means decreases a size and a weight of the platform system.

The embodiments shown and described above are only examples. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A platform system comprising:
at least one electric motor;
at least one flexible cable;
a main controlling device comprising a controlling circuit and at least one driving circuit electrically connected to the controlling circuit, the at least one driving circuit being electrically connected to the at least one electric motor through the at least one flexible cable.

2. The platform system of claim 1, wherein the at least one electric motor comprises two electric motors, the at least one flexible cable comprises two flexible cables, and the at least one driving circuit comprises two driving circuits.

3. The platform system of claim 1, wherein the at least one electric motor comprises three electric motors, the at least one flexible cable comprises three flexible cables, and the at least one driving circuit comprises three driving circuits.

4. The platform system of claim 1, wherein the at least one flexible cable is selected from the group consisting of flexible printed circuit, ribbon cable, multi-wire planer cable, and flexible flat cable.

5. The platform system of claim 1, wherein the controlling circuit and the at least one driving circuit are mounted together.

6. The platform system of claim 1, wherein the at least one electric motor comprises a conducting wire having a first end extended out and connected to the at least one driving circuit through the at least one flexible cable.

7. The platform system of claim 6, wherein the conducting wire is an enamel insulated wire.

8. The platform system of claim 6, wherein the first end of the conducting wire is joined with the at least one flexible cable through a metal-joining means selected from the group consisting of welding, soldering, and brazing.

9. The platform system of claim 8, further comprising at least one metal-joining plate comprising a base board and a joining member located on the base board, the joining member is connected to the at least one flexible cable, the joining member is configured to join the first end of the conducting wire.

10. The platform system of claim 9, wherein the joining member is a solder terminal having the conducting wire soldered thereon.

11. The platform system of claim 10, wherein the solder terminal is selected from the group consisting of solder protrusion, solder ring, and solder lug.

12. The platform system of claim 1, wherein each electric motor comprises three conducting wires having a first end extended out, and each metal-joining plate comprises three joining members configured to respectively join the first end of the three conducting wires.

13. The platform system of claim 1, wherein the controlling circuit and the at least one driving circuit are mounted on one circuit board.

14. The platform system of claim 1, wherein the at least one electric motor is configured to rotate a payload about at least one axis.

15. The platform system of claim 3, wherein the three electric motors are configured to rotate a payload about three rotating axes.

16. The platform system of claim 15, wherein the three rotating axes are a pitch axis, a roll axis, and a yaw axis, respectively.

17. A platform system comprising:
a first electric motor, a second electric motor, and a third electric motor;
a first flexible cable, a second flexible cable, and a third flexible cable; and
a main controlling device comprising a controlling circuit, a first driving circuit, a second driving circuit, and a third driving circuit,
wherein the first driving circuit, the second driving circuit, and the third driving circuit are electrically connected to the controlling circuit, the first driving circuit is electrically connected to the first electric motor through the first flexible cable, the second driving circuit is electrically connected to the second electric motor through the second flexible cable, and the third driving circuit is electrically connected to the third electric motor through the third flexible cable.

18. The platform system of claim 17, wherein at least one of the first flexible cable, the second flexible cable and the third flexible cable is a flexible printed circuit.

19. The platform system of claim 18, wherein the flexible printed circuit is electrically connected to enamel insulated wires extended out from the at least one of the first electric motor, the second electric motor and the third electric motor by a metal-joining plate.

20. A platform system comprising:
at least one electric motor;
at least one flexible printed circuit;
a main controlling device comprising a controlling circuit and at least one driving circuit electrically connected to the controlling circuit, the at least one driving circuit being electrically connected to the at least one electric motor through the at least one flexible printed circuit.
